(19) United States
(12) Patent Application Publication
(10) Pub. No.: US 2012/0023598 A1
(43) Pub. Date: Jan. 26, 2012

(54) BIOS USB WRITE PREVENT

(75) Inventor: Luke M Mulcahy, Houston, TX (US)

(73) Assignee: Hewlett-Packard Development Company, L.P., Houston, TX (US)

(21) Appl. No.: 13/260,315

(22) PCT Filed: Mar. 31, 2009
(86) PCT No.: PCT/US09/38955

§ 371 Date: Sep. 25, 2011

(51) Int. Cl. G06F 21/00

(52) U.S. Cl. 726/32

(57) ABSTRACT

A basic input output system (BIOS) (32) prevents writing of data to a universal serial bus (USB) storage device (40).

BACKGROUND

Operating systems sometimes include measures to prevent unauthorized copying of data to a universal serial bus (USB) mass storage device. Such measures may be circumvented, leaving open the possibility for unauthorized copying of data to a USB device.

### BRIEF DESCRIPTION OF THE DRAWINGS

FIG. 1 is a schematic illustration of a computing system according to an example embodiment.

FIG. 2 is a flow diagram of a method for inhibiting unauthorized copying of data from the computing system of FIG. 1 to a USB device according to an example embodiment.

FIG. 3 is a flow diagram of a particular embodiment of the method of FIG. 2 according to an example embodiment.

### DETAILED DESCRIPTION OF THE EXAMPLE EMBODIMENTS

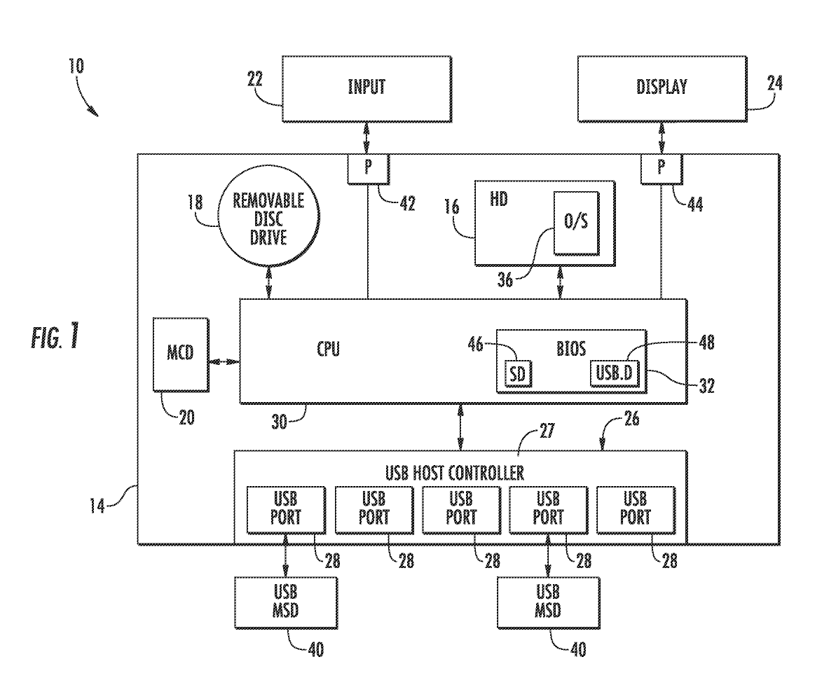

FIG. 1 is a schematic illustration of a computing system 10 according to an example embodiment. As will be described hereafter, computing system 10 provides enhanced safeguards against unauthorized copying of data from the computing system 10 to external devices through a universal serial bus (USB) port. Computing system 10 comprises motherboard 14, hard drive 16, removable disk drive 18, memory card drive 20, input 22, display 24, USB system 26 including controller 27 and USB ports 28, central processing unit 30 and basic input output system (BIOS) 32.

Motherboard 14 comprises a main circuit board by which all other internal components of computing system 10 connect. For example, in one embodiment, motherboard 14 is directly connected to central processing unit 30 and BIOS 32. Other components are connected to motherboard 14 through secondary connections such as by being built into motherboard 14 or connected through an expansion slot. In other embodiments, other structures may be used to interconnect various internal components of computing system 10.

Hard drive 16 comprises a large capacity permanent storage configured to hold information such as programs and documents. In one embodiment, hard drive 16 may include discs or platters for recording and reading data. In other embodiments, hard drive 16 may comprise a solid-state drive or flash-based drive.

As shown by FIG. 1, hard drive 16 includes operating system 36. Operating system 36 comprises software or programming stored on the memory provided by hard drive 16. Operating system 36 facilitates interface between a person and computing system 10. In one embodiment, operating system 36 is installed onto hard drive 16 via removable disk drive 18, media card drive 20 or other inputs.

According to one embodiment, operating system 36 may comprise an operating system that lacks low-level disk services or low level routines, such as services that facilitate communication with external USB devices. In such an embodiment, the operating system 36 invokes BIOS 32 for providing such low level disk services or routines, For example, in one embodiment, operating system 36 may comprise a disk operating system (DOS). For purposes of this disclosure, the term DOS operating system refers to an operating system constituting a single-user, single-task operating system with basic kernel functions that are non-reentrant: only one program at a time can use them. Some DOS systems provide an exception with Terminate and Stay Resident (TSR) programs, and some TSRs can allow multitasking. One example of a DOS operating system is an operating system that runs on machines with INTEL X86 or compatible central processing units, With such DOS operating systems, viewing system 10 utilizes BIOS 32 when reading from and writing to external devices such as a USB mass storage device 40.

In another embodiment, operating system 36 may comprise an operating system that includes low-level disk services, In other words, operating system 36 may comprise an operating system that includes drivers or software portions facilitating communication with external devices, such as through USB ports 28, without utilizing low levels disk services or low level routines that may also be provided in BIOS 32. One example of such an operating system is a WINDOWS based operating system such as WINDOWS XP or WINDOWS VISTA operating systems.

Removable disk drive 18 and media card drive 20 comprise drives or devices by which portable mass storage devices may access for reading or writing. Removable disk drive comprises a drive configured to receive a disk and to read and/or write to or from the disk. Examples of such disks include, but are not limited to, compact discs (CDs), digital versatile disks (DVDs) and blue-Ray discs. In some embodiments, computing system 10 may omit removable disk drive 18 or may include multiples of such removable disk drive 18.

Media card drive 20 comprises a driver device configured to receive a media card or flash memory card. Media drive 20 is configured to read from or write to such a media card. Such media cards comprise electrically erasable programmable read-only memory (EEPROM), Examples of such flash memory media cards include, but not limited to, CompactFlash, Smart Media and PCMCIA cards. In some embodiments, computing system 10 may omit media card drive 20 or may include multiples of media card drive 20.

Input 22 comprises one or more devices configured to facilitate input or entry of data or commands by a person to computing system 10. Examples of input 22 may include one or more of a keyboard, a mouse, a touchpad, a touch screen, and microphone with voice recognition software, a stylus and the like. In one embodiment of input 22 is external to the remainder of computing system 10 and is connected or plugged into computing system 10 via a port 42. In another embodiment, input 22 may be incorporated into a housing or body of computing system 22, such as a touchpad or touch screen on a laptop computer,

Display 24 comprises a device configured to present information to a person using computing system 10. In one embodiment, display 24 comprises a screen or monitor. In one embodiment, display 24 is external to remainder of computing system 10 and is connected or plugged into computing system 10 via a port 44. In another embodiment, display 24 may be incorporated into a housing or body of computing system 22, such as a display screen on a laptop computer.

USB host controller 26 comprises a controller which directs traffic flow to external devices through USB ports 28. USB ports 28 comprise points at which external USB devices may be connected to computing system 10. For purposes of this disclosure, USB port is any port configured to be connected to a USB connector of any USB device. Examples of USB ports and devices include any USB port and device including all past, present and future iterations under the USB specification. Examples of USB ports or devices include USB 1.0, USB 2,0, USB 3.0 and future iterations or specifications thereof. USB ports 28 may be configured to receive various types of USB connectors, including, but not limited to, Type A connectors, Type B connectors, Mini-A connectors, Mini-B connectors, Micro-AB connectors, Micro-B connectors and 8-pin AGOX connectors.

As shown by FIG. 1, USB ports 28 are configured to be connected to USB mass storage devices 40. In one embodiment, USB mass storage devices comprise devices under the USB device classification 08 h which includes devices such as USB flash drives, memory card readers, digital audio players, digital cameras and external drives. Such mass storage devices have the capability of having data copied to, stored upon, or written upon such USB mass storage devices.

Central processing unit (CPU) 30 comprises a processing unit that serves as the microprocessor brain of computer system 10. For purposes of this application, the term “processing unit” shall mean a presently developed or future developed processing unit that executes sequences of instructions contained in a memory, Execution of the sequences of instructions causes the processing unit to perform steps such as generating control signals. The instructions may be loaded in a random access memory (RAM) for execution by the processing unit from a read only memory (ROM), amass storage device, or some other persistent storage. In other embodiments, hard wired circuitry may be used in place of or in combination with software instructions to implement the functions described. Central processing unit 30 uses assembly language and oversees most, if not all, operations of computing system 10. During startup of computing system 10 and during operation of computing system 10, central processing unit 30 follows instructions at least in part provided by BIOS 32.

BIOS 32 comprises a type of read only memory (ROM) containing instructions for operations of central processing unit 30. In one embodiment, BIOS 32 is embodied as a flash memory chip. BIOS 32 is configured to assist in the startup or boot of computing system 10. In one embodiment, BIOS 32 is configured to perform tasks including, but not limited to, (1) a power-on self-test (POST) for different system hardware components, (2) activating other BIOS chips on different cards installed in computing system 10 such as those found in small computer system interface (SCSI) and graphics cards, (3) managing settings for hard drive 16, a clock of computing system 10 and the like; and (4) providing a set of low-level routines utilized by operating system 36 interface to different hardware devices. Such low-level routines or low-level disk services manage interfacing with input 22, display 24 and serial and parallel ports.

In one embodiment, BIOS 32 includes, amongst others, a BIOS storage driver 46 and a BIOS USB driver 48. Storage driver 46 comprises a driver or software segment configured to receive and handle commands from operating system 36 and to convert or translate such commands receive from operating system 36 into a language appropriate for the hardware addressed by the command. For example, in one embodiment, storage driver 46 is configured to receive operating system commands addressed to a USB device and to translate or convert the O/S command to a language appropriate for the USB device.

BIOS USB driver 48 comprises a driver or software segment configured to receive and handle USB commands generated by storage driver 46. Depending upon settings of BIOS 32, BIOS USB driver 48 either transmits and completes the USB command (corresponding to the operating system command addressed to the USB device) or blocks, rejects or otherwise prevents transmission or completion of the USB command. In particular, if BIOS 32 has been set or has a setting indicating that writing to USB devices, such as USB mass storage device 40 or the copying of data from computing system 10, such as from hard drive 16, to USB mass storage device 40 is prohibited, BIOS 32 rejects the command. Upon rejection of the command, BIOS 32 also causes a command incompletion notification or error status to be ultimately presented by display 24. As a result, the person attempting to from computing system 10 to USB mass storage device 40 is notified that such copying of data is not authorized.

Although not illustrated, computing system 10 include other internal components. For example, computing content may additionally include various other types of memory such as random access memory, read only memory, caching memory, virtual memory and the like. Computing system 10 may include a power supply for regulating electricity used by computing system 10. Computing system 10 may also include an integrated drive electronics controller, accelerated graphics port, a sound card, a graphics card, a real-time clock, a complementary metal-oxide semiconductor battery, various fans, heat sinks and cooling systems. Computing system 110 may additionally include network devices or other components.

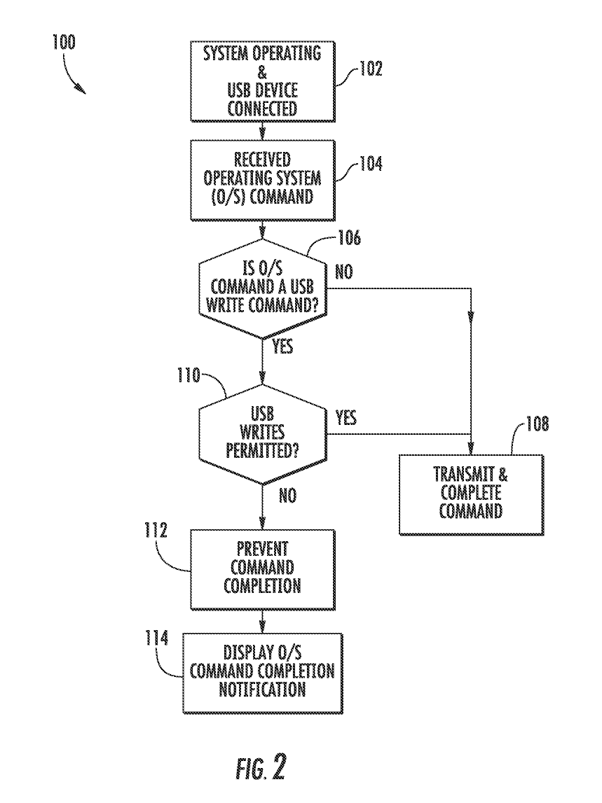

FIG. 2 is a flow diagram illustrating a process or method 100 that may be carried out by computing system 10. As indicated by step 102, at the initiation of method 100, computing system 10 is operating and has been booted up by BIOS 32. USB mass storage device 40 also been connected or plugged into one of USB ports 28. According to method 100, computing system 10 operates pursuant to a booted operating system lacking low-level disk services or low-level routines, meaning that the booted operating system must utilize such low-level disk services or low-level routines provided by BIOS 32. For example, when interfacing with a USB device, such as USB mass storage device 40, the operating system utilizes storage device 46 and USB driver 48 of BIOS 32, In one embodiment, the booted operating system may comprise operating system 36 on hard drive 16. In another embodiment, the booted operating system 36 may comprise an operating system booted from a disk loaded in removal of this drive 18, may be booted from a media card inserted in media card driver or media card slot 20, may be booted from a USB mass storage device or other USB device connected via a USB port 28 or may be booted from other external sources. In those embodiments in which the booted operating system is booted from an external source, any copying or write protections contained in the dormant operating system 36 on hard drive 16 are circumvented.

As indicated by step 104, computing system 10 receives an operating system (O/S) command via input 22 requesting a data (data packets) or information be written to or copied to USB mass storage device 40 from computing system 10.

As indicated by step 106, central processing unit 30, utilizing the low-level disk sources or tow-level routines on BIOS 32 and following instructions contained in BIOS 32, determines whether the operating system command is a USB write command. In other words, central processing unit 30 determines whether the operating system command is requesting that data be copied from computing system 10 to USB mass storage device 40. According to one embodiment, central processing unit 30, following instructions of storage driver 46 first converts or translates the operating system command to a command language appropriate for the hardware addressed by the command. If the original operating system command is addressing a USB device, central processing unit 30, following instructions of USB driver 48, determines whether the now USB command is indeed a USB write command.

Alternatively, in other embodiments, BIOS 32 may direct central processing unit 30 to make the determination of whether the operating system command is a USB write command at other points in time. For example, in other embodiments, BIOS 32 may alternatively direct central processing unit 30 to examine the operating system command to determine whether it is a USB write command before the operating system command has been translated by storage drive 46. In such an embodiment, BIOS 32 may direct central processing unit 30 to determine whether the operating system command is for USB device and then determine whether the operating system command is a write or out command.

As indicated by step 108, if the operating system command or the translated operating system command is not a USB write command or a USB out of command, BIOS 32 direct central processing unit 32 transmit the translated operating system command and to complete the command. As indicated by step 110, if the translated. operating system command or the operating system command is identified as a USB write or out of command, central processing unit 30 checks the current settings of BIOS 32 to determine whether USB writes or outs are currently permitted. As once again indicated by step 108, if the current settings of BIOS 32 permit or allow USB writes or outs (copying of data to an external USB mass storage device), central processing unit 30 transmits the command and completes the command.

However, as indicated by step 112, if the current settings of BIOS 32 indicate that USB writes or outs are not permitted, USB driver 48 of BIOS 32 directs central processing unit 30 through event completion of the operating system command or the translated operating system command. In other words, the write or out command is rejected and transmission of the write or out command to the USB mass storage device 40 is blocked,

As indicated by step 114, this further result of the display of an operating system command incompletion notification or error status. This incompletion notification is presented on display 24 by central processing unit 30. In one embodiment, central processing unit 30 following the instructions of USB driver 48 generates an error status in the USB device language. Following instructions of storage driver 46, central processing unit 30 translates the USB device language error status message to the language of the operating system. The booted operating system then displays the error message or command incompletion notification on display 24.

Overall, BIOS 32 protects computing system 10 by inhibiting or preventing unauthorized copying of data from computing system 10 to an external USB mass storage device. BIOS 32 more securely protects data on computing system 10 as compared to protections provided at the operating system level. In particular, protections at the operating system level, such as those that may be contained on operating system 36 installed on hard drive 16, may be circumvented by a person booting to an alternative operating system contained on an external source such as a removable disk using disk drive 18, contained on a removable media card using media card drive 20, contained on a USB memory storage device using USB port 28 or contained on another external source for an alternative operating system that may omit such data security measures. BIOS 32 prevents the unauthorized copying of data to a USB mass storage device when computing system 10 is booted to an alternative operating system that omits low-level disk services or low-level routines or in those computing systems 10 that utilize an operating system 36 which itself omits low level disk services or low-level routines or which itself omits any data security measures against USB data transfers.

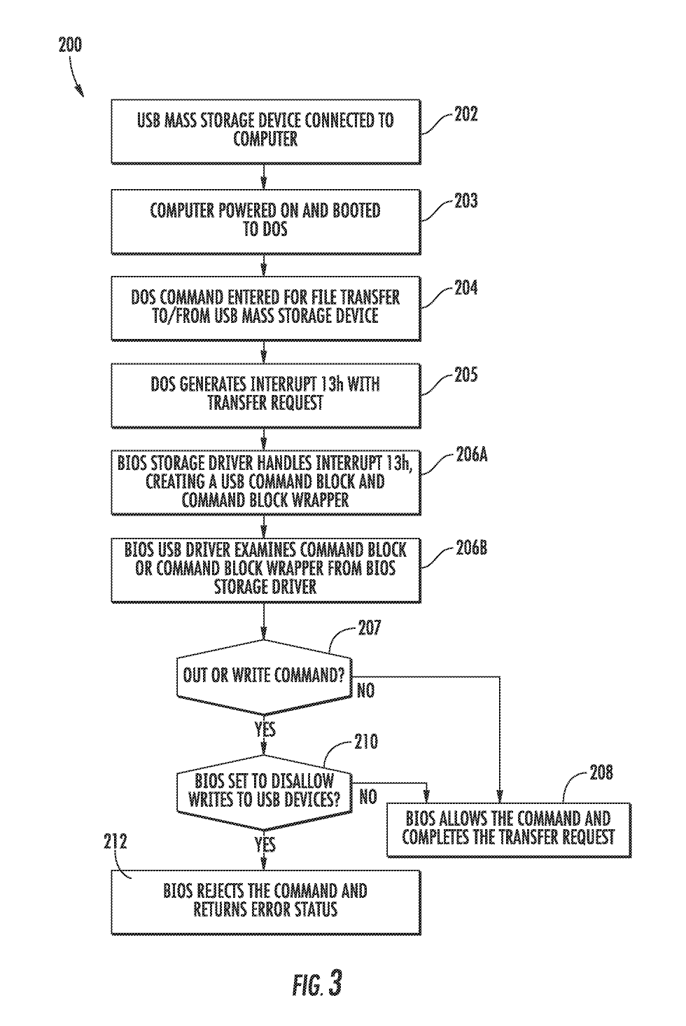

FIG. 3 is a flow diagram of method 200, a particular embodiment of method 100 shown and described with respect to FIG. 2. As indicated by step 202, a USB mass storage device 40 is connected to a computing system such as computing system 10. As indicated by step 203, computing system 10 is powered on and booted to DOS. In other embodiments, computing system 10 may be powered on and booted to DOS prior to connection of the USB mass storage device 40 to computing system 10 via one of ports 28. In other words, steps 202 and 203 may be switched.

As indicated by step 204, a DOS command is entered for file transfer to the USB mass storage device 28. Such a DOS command may be entered using input 22 while the DOS operating system is running As indicated by step 205, the DOS operating system generates an interrupt 13 h call with the transfer request. This interrupt 13 h call invokes the operation of or services of BIOS 32.

As indicated by step 206A, storage driver 46 of BIOS 32 handles a response to the interrupt 13 h in a function call and creates a USB command block and command block wrapper. In other words, storage device 46 creates a packet by translating the original DOS command or DOS request.

As indicated by step 206B, USB driver 48 of BIOS 32 examines the command block or the command block wrapper received from the RIOS storage driver 46. As further indicated by step 207, the BIOS USB driver 48 determines whether the command. block or command block wrapper is for an out or write command (a request to copy data from computing system 10 to a USB mass storage device 40).

As indicated by step 208, if the command block or command block wrapper is not an out or write command, BIOS 32 allows the command and completes the command. For example, if the command block or command block wrapper is merely a request for transfer of data but is not an out or write command, the transfer quest is completed. In one embodiment, the command is transmitted to the USB device notifying the USB device that the data is about to be transmitted, wherein the data is subsequently transmitted.

As indicated by step 210, if the USB driver 48 of BIOS 32 determines that the command block or command block wrapper does include an out or write command, USB driver 48 then checks current settings of BIOS 32 to determine whether such settings disallow writes to USB devices. Once again, as a gated by step 208, if BIOS 32 is not set to disallow writes to USB devices, BIOS 32 allows the command and completes the transfer request. In other words, the command is transmitted to the USB device in the data to be written to the USB devices subsequently transferred.

However, as indicated by step 212, if the current settings of BIOS 32 are set to disallow writes to USB devices, BIOS 32 rejects the command and returns an error status. In other words, the command is not transmitted to the USB device and data from computing system 10 is not transmitted to the USB device. USB driver 48 further returns an error status to storage driver 46. Source driver 46 of BIOS 32 returns an error message to the DOS operating system. The DOS operating system then causes the error message or predetermined error message to be presented on display 24 notifying a person of incompletion of the command.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

1. An apparatus comprising:
a basic input output system (BIOS) memory device having instructions configured to direct a processor to determine whether an operating system command received from an operating system comprises an out or write command for writing data to a universal serial bus (USB) storage device and to prevent completion of the operating system command if the command comprises an out or write command for writing data to the USB storage device.

2. The apparatus of claim 1, wherein the BIOS memory device comprises:
a storage driver configured to translate the operating system command to a USB command; and
a USB driver configured to examine the USB command to determine whether the USB command comprises an out or write command to write data to a USB storage device.

3. The apparatus of claim 2, wherein the USB driver is configured to return a first command incompletion notification to the storage driver indicating that the operating system command was not completed and wherein the storage driver is configured to return a second command incompletion notification to the operating system indicating that the operating system command was not completed.

4. The apparatus of any of claims 1, wherein the operating system lacks at least one of an operating system USB driver and an operating system storage driver.

5. The apparatus of any of claims 1, wherein the operating system comprises a disk operating system (DOS).

6. The apparatus of any of claims 1, wherein the operating system command comprises a disk operating system (DOS) command.

7. The apparatus of any of claims 1 further comprising:
a motherboard connected to the BIOS memory device;
a central processing unit connected to the motherboard and the BIOS memory device; and
a USB input/output port connected to the motherboard.

8. The apparatus of claim 6, wherein the BIOS memory device includes instructions configured direct the processor to output an operating system command incompletion notification to the operating system upon prevention of completion of the operating system command.

9. A method comprising:
receiving an operating system command from an operating system;
following instructions in a basic input output system (BIOS), determining whether the operating system command comprises an out or write command for writing data to a universal serial bus (USB) storage device; and
preventing completion of the operating system command if the operating system command comprises the out or write command to for writing data to the universal serial bus storage device.

10. The method of claim 9 further comprising:
translating the operating system command to a USB command; and
examining the USB command to determine whether the USB command comprises an out or write command to a USB storage device.

11. The method of any of claims 9, wherein the operating system command comprises a disk operating system (DOS) command.

12. The method of any of claims 9, wherein the operating system command comprises a disk operating system (DOS) command.

13. The method of any of claims 9 further comprising displaying an incompletion or error notification if the operating system command is not completed.

14. The method of any of claims 9, wherein the receiving, determining and the preventing are performed according to instructions provided by the basic input output system (BIOS) memory device.

15. The method of any of claims 9 further comprising:
reading a BIOS setting of the BIOS memory device to determine whether universal serial bus (USB) writes are permitted;
wherein the operating system command is completed if USB writes are permitted; and
wherein completion of the operating system command is prevented if USB writes are not permitted.
